(19) United States
(12) Patent Application Publication
(10) Pub. No.: US 2026/0335714 A1
(43) Pub. Date: Oct. 29, 2026

(54) Artificial Intelligence-Based Sports Analysis and Strategy Optimization System

(71) Applicants: Amit Somen, Novi, MI (US); Casey J Wakula, Novi, MI (US); Michael Helms, Novi, MI (US)

(72) Inventors: Amit Somen, Novi, MI (US); Casey J Wakula, Novi, MI (US); Michael Helms, Novi, MI (US)

(21) Appl. No.: 19/192,364

(22) Filed: Apr. 29, 2025

Related U.S. Application Data
(60) Provisional application No. 63/702,338, filed on Oct. 2, 2024.

(51) Int. Cl. A63B 24/00

(52) U.S. Cl. CPC A63B 24/0062

(57) ABSTRACT

The present invention is an artificial intelligence (AI)-driven decision-support system designed to analyze real-time and historical data across multiple domains, including sports performance analysis, medical diagnostics, emergency response, aviation safety, and mental health assessment. By integrating machine learning, computer vision, predictive modeling, and natural language processing (NLP), the system processes video footage, sensor data, biometric readings, and environmental factors to identify patterns, predict future outcomes, and provide real-time strategic recommendations. In sports applications, the system analyzes player movements, biomechanical efficiency, opponent tendencies, and game strategies, providing coaches and athletes with tactical insights, predictive game plans, and individualized performance corrections.

### BACKGROUND OF THE INVENTION

### Field of Invention

The present invention relates to the field of sports analytics and artificial intelligence (AI)-driven performance evaluation. More specifically, the invention pertains to an AI-powered system for analyzing athletic game footage, identifying trends, detecting behavioral patterns, and generating predictive insights to enhance game strategy, player development, and scouting. The invention further integrates machine learning models trained on historical sports data to provide real-time and post-game analysis, enabling athletes, coaches, and scouts to make data-driven decisions with increased accuracy and efficiency.

### BRIEF SUMMARY OF THE INVENTION

The present invention is an artificial intelligence (AI)-driven sports analysis system that automates the breakdown of athletic game footage to identify trends, player tendencies, behavioral patterns, and strategic cues. By leveraging machine learning, the system processes data from multiple games, analyzing every quarter, play, and individual player to generate predictive insights. This enables athletes, coaches, and analysts to make informed decisions by understanding how opponents react in various situations. The system further calculates movement angles, play formations, and biomechanical factors to provide a comprehensive evaluation of in-game dynamics. By continuously updating its knowledge base, the AI refines its ability to anticipate strategies and recommend optimal courses of action. For example, tendencies based on field positioning can be used so that if the ball is at −30 yard line, teams on 1^{st} down are likely to do “X”. Down and distance tendencies can also be incorporated.

Beyond in-game analysis, the system functions as a virtual coaching and scouting assistant, allowing users to query specific gameplay scenarios and receive real-time, data-driven feedback. Athletes can use the system to recognize and eliminate their own “tells”—subtle behaviors that may give away intentions—while scouts can leverage the AI to identify promising players based on customized performance criteria. The invention reduces the need for time-intensive manual film review, offering a faster and more precise method for optimizing game strategy, player development, and talent scouting. The tool is also used for 1:1 training in that the coach or trainer can quickly identify the areas of improvement and areas of excellence. There is a large market for “private training” and this is a competitive edge for that trainer.

### BRIEF DESCRIPTION OF THE FIGURES

FIG. 1 illustrates a process according to an embodiment of the present invention.

### DETAILED DESCRIPTION

The present invention is an artificial intelligence (AI)-driven sports analysis and strategy optimization system designed to automate and enhance the process of breaking down athletic game footage. By utilizing advanced machine learning models, computer vision techniques, predictive analytics, and natural language processing, the system evaluates player movements, team formations, biomechanical patterns, and in-game decision-making to provide users with a comprehensive, data-driven breakdown of individual and team performances. The invention is designed to streamline and optimize game preparation, player development, scouting assessments, and fan engagement, allowing athletes, coaches, analysts, and sports organizations to make informed decisions with significantly reduced manual effort by supplementing the need for traditional film study methods, which require hours of manual review, subjective interpretation, and expert analysis, this system presents an automated, objective, and highly detailed evaluation of every aspect of the game, offering real-time and post-game insights that were previously inaccessible or required extensive human intervention to compile. This reduces human error and enhances analytics by reviewing frame by frame analysis of each play/player.

The core functionality of this invention revolves around AI-powered sports performance analysis, which provides an in-depth breakdown of how individual players, entire teams, and even entire leagues evolve over time. By analyzing each play, formation, quarter, and full game in detail, the system is capable of detecting micro-level trends—such as minute variations in a basketball player's shot mechanics when guarded by different types of defenders—as well as macro-level patterns, such as how an opposing team adjusts its offensive/defensive scheme when trailing in the fourth quarter.

The AI processes frame-by-frame breakdowns of game footage, extracting precise angles, velocities, and movement tendencies to map out every player's exact positioning, biomechanical form, and reaction time in any given play. For instance, in football, the AI can track how a quarterback's release angle changes under pressure or how a defensive back's hip movement affects their coverage ability. In basketball, the system can determine whether a player's shooting accuracy is affected by fatigue based on biomechanical data captured in the latter half of games. In baseball, the AI can detect whether a pitcher's arm slot subtly shifts between different pitch types, providing critical intelligence for batters and hitting coaches.

A key feature of this invention is its ability to map behavioral patterns and strategic decision triggers, helping teams and athletes not only react to opponents but also anticipate their future decisions. The AI is capable of identifying when specific game situations trigger certain responses from players or coaches. For example, if a soccer team consistently shifts to a 4-3-3 formation in the final 15 minutes of a game when trailing, or if a basketball player tends to favor driving to their dominant hand in high-pressure situations, these tendencies will be flagged, analyzed, and presented as actionable intelligence. The system evaluates not just what players do, but why they do it, allowing teams to strategize with higher precision than ever before. Furthermore, athletes can utilize this system to identify their own subconscious “tells” and tendencies—such as a tennis player slightly adjusting their grip before executing a drop shot or a golfer shifting their weight subtly before attempting a specific type of putt—allowing them to refine their technique and eliminate habits that may be exploited by opponents.

Beyond performance analysis, another major embodiment of this invention is its application in automated scouting and talent evaluation. Traditional scouting methods rely heavily on in-person observations, limited sample sizes, and subjective assessments of player potential, all of which introduce bias and inefficiencies into the talent identification process. This invention provides a data-driven alternative, offering comprehensive scouting reports based on empirical performance metrics, historical progression, and predictive modeling of a player's future development trajectory. The AI can analyze player statistics, biomechanical efficiency, reaction speed, endurance levels, and adaptability to various game conditions, allowing scouts and recruiters to identify promising athletes based on quantifiable performance indicators rather than subjective perception. For example, the system can rank football linebackers by their average time to react to a snap, basketball point guards by their assist-to-turnover ratio in clutch situations, or baseball hitters by their ability to adjust to off-speed pitches mid-game. The scouting function is also capable of identifying undervalued or overlooked players, as it can compare athletes across different leagues and historical benchmarks to detect those whose skill sets align with elite-level players, even if they are currently underappreciated in traditional scouting circles. Conversely, “good” players that play in lower tiered leagues may have stats that jump off the map. The tool can identify other athletes of similar level of play. For example, if a kid is playing basketball against a highly recruited player and he holds that guy to 7 points and he scores 22 himself, the invention can dump that level detail into the AI.

Another major embodiment of the invention is a fan engagement platform, which provides spectators with interactive AI-driven sports analytics to enhance their viewing experience. Fans will have the ability to log into a dedicated AI-assisted interface that allows them to compare current athletes with past legends, gaining insights into how modern players stack up against historical greats based on performance trends, efficiency ratings, and statistical breakdowns. For instance, a fan could request a side-by-side comparison of a contemporary quarterback against Hall of Fame players, analyzing differences in passing accuracy under pressure, scrambling efficiency, and decision-making tendencies. Similarly, the system can generate real-time predictions for ongoing games, such as estimating the likelihood of a team executing a comeback based on historical patterns or determining which defensive adjustments are most likely to succeed against an opponent's offensive scheme. For example, it is known to offer a win/loss probability based on score, time left, possession, etc. Fans will also have access to customizable highlight reels, where they can input queries like, “Show me every game-winning three-pointer made by Player X in the last five seasons,” or “Generate a highlight reel of the best defensive stops by Team Y in championship games.” This feature provides a level of sports engagement far beyond what traditional highlight packages offer, as it allows users to customize their own analytics-driven storytelling experience.

The AI assistant embedded within the system further enhances usability by allowing users to interact with the AI through natural language queries, enabling athletes, coaches, scouts, and fans to receive instant, tailored analysis without needing deep technical knowledge of statistical modeling. A coach could ask, “What defensive schemes have been most effective against this team in the past five years?” and receive a detailed breakdown of successful formations, player matchups, and in-game adjustments. A basketball player could ask, “How do my shooting percentages change when guarded by taller defenders?” and the system would generate personalized insights with suggested training adjustments. The AI assistant effectively acts as a digital coaching, scouting, and analytical consultant, reducing the need for users to manually sift through mountains of data.

From a technical perspective, the system leverages deep learning neural networks, convolutional neural networks (CNNs) for motion tracking, natural linguistic processing (NLP) for interactive analysis, and reinforcement learning models for predictive recommendations. The AI continuously refines its accuracy by processing live game data, historical footage, and real-time player tracking data, ensuring that its analysis remains current, adaptive, and relevant to evolving game trends. The system is trained on vast datasets, incorporating publicly available sports archives, proprietary team data, and biomechanical performance studies to develop a robust and highly adaptable AI model.

By integrating automated film study, AI-powered strategic insights, real-time predictive analytics, and interactive fan engagement, this invention revolutionizes how sports analysis is conducted at every level. It eliminates inefficiencies in traditional film review, enables athletes to optimize their performance with data-driven insights, provides scouts with objective talent assessments, and delivers fans an unprecedented depth of sports analytics in an interactive format. This system represents a paradigm shift in sports intelligence, transforming subjective coaching decisions, scouting reports, and game analysis into precise, AI-generated intelligence that redefines how the game is played, studied, and understood.

Beyond its primary application in sports analysis, the present invention can also be adapted for medical and mental health applications, utilizing the same AI-driven framework to analyze real-time data and provide predictive insights for clinical decision-making and psychological assessments.

In a surgical assistance embodiment, the AI system is configured to integrate with live medical imaging, patient monitoring systems, and electronic health records (EHRs) to assist surgeons in real-time. By continuously analyzing a patient's vital signs, surgical progress, tissue responses, and historical medical data, the AI can identify potential complications before they become critical, suggest optimal intervention strategies, and alert medical professionals to unexpected changes in patient status. For example, during a complex cardiac procedure, the AI could analyze blood pressure trends, oxygen saturation levels, and heart rhythm patterns, predicting possible adverse events such as an impending arrhythmia or excessive blood loss. The system could also recommend real-time adjustments to surgical techniques based on data from previous successful procedures, enhancing surgical precision and patient safety. This AI-driven decision support tool could reduce surgical errors, optimize intraoperative strategies, and improve overall patient outcomes.

Additionally, in a mental health and behavioral analysis embodiment, the system can be used to detect early warning signs of psychological distress, pre-suicidal ideation, pre-homicidal tendencies, or criminal intent by analyzing a person's tone of voice, facial expressions, speech patterns, physiological responses, and behavioral cues. By integrating with therapist evaluation tools, law enforcement risk assessment platforms, and crisis intervention systems, the AI could provide real-time alerts to mental health professionals, helping them identify individuals at risk before a crisis occurs. The system would function by continuously monitoring subtle linguistic patterns, micro-expressions, and biometric indicators, allowing therapists to intervene proactively. For example, if an individual exhibits increased vocal stress markers, erratic speech pacing, or physiological signs of distress, the AI could notify the therapist and suggest specific therapeutic interventions based on historical case studies and psychological models.

In a law enforcement and public safety embodiment, the AI could be integrated into security monitoring systems, forensic psychology assessments, and correctional facility evaluations to detect potentially dangerous behaviors before they escalate into criminal actions. By evaluating a suspect's nonverbal cues, conversation patterns, and previous behavioral data, the system could help predict escalation risks, flag potential threats, and recommend de-escalation techniques. Additionally, the AI could assist parole officers, school counselors, and social workers by continuously assessing behavioral data of at-risk individuals, enabling early interventions that reduce the likelihood of violent or criminal actions.

By applying the same AI-based pattern recognition, predictive modeling, and real-time analytics used in sports analysis, the present invention extends beyond athletics and into high-impact medical and mental health domains. These additional embodiments offer significant benefits in patient safety, surgical precision, mental health crisis intervention, and public security, demonstrating the broad applicability of the system's core AI technology across multiple industries.

Beyond sports analysis, medical applications, and mental health assessments, the present invention can also be adapted to provide real-time AI-driven decision support for firefighters, pilots, emergency medical services (EMS), and other first responders. By leveraging the system's predictive analytics, real-time data processing, and pattern recognition capabilities, this embodiment enhances situational awareness, risk assessment, and strategic decision-making in high-stakes environments where split-second judgments can mean the difference between life and death.

In a firefighting embodiment, the AI system can integrate with thermal imaging cameras, environmental sensors, drone surveillance feeds, and firefighter biometric monitors to analyze fire conditions in real time and provide strategic recommendations for containing and extinguishing fires. The system would process data from building layouts, wind patterns, oxygen levels, and fire spread trajectories, predicting the most effective approach for fire suppression while also identifying potential hazards such as structural collapses, gas leaks, or flashover risks. The AI could also provide individualized risk assessments for each firefighter, monitoring their oxygen levels, heart rate, core body temperature, and exertion levels to prevent exhaustion, dehydration, or heatstroke. If a firefighter's vitals indicate critical fatigue or distress, the system could issue an immediate evacuation alert or recommend tactical repositioning. Additionally, AI-driven drone surveillance could provide real-time heat maps and escape route recommendations for both first responders and civilians trapped inside burning structures.

In an aviation embodiment, the system can assist pilots in managing emergency situations, optimizing flight performance, and reducing human error during critical phases of flight. Integrated with cockpit instrumentation, aircraft telemetry, weather data, and historical flight performance logs, the AI can provide real-time diagnostics, predictive failure warnings, and adaptive emergency protocols. For instance, in the event of engine failure, extreme turbulence, or rapid cabin depressurization, the AI would analyze thousands of past incidents, cross-reference aircraft specifications, and provide the pilot with the best course of action in milliseconds. If an aircraft encounters unexpected severe weather, runway obstructions, or autopilot malfunctions, the AI could offer pilots instant corrective measures based on real-time aeronautical calculations. The system could also be programmed to detect pilot fatigue, cognitive overload, or stress markers, issuing alerts or even recommending co-pilot intervention or automated system engagement to prevent accidents caused by human error.

In an emergency medical services (EMS) embodiment, the AI system can assist paramedics, emergency physicians, and trauma response teams by analyzing real-time patient data, medical histories, and environmental factors to optimize emergency care in ambulances or disaster zones. The system would integrate with portable diagnostic equipment, real-time vital sign monitors, and hospital databases to provide instant triage recommendations, medication dosage calculations, and pre-hospital treatment strategies. For example, when responding to a multi-vehicle crash or a mass casualty event, the AI could prioritize which patients require immediate stabilization versus delayed transport, ensuring optimal resource allocation and treatment efficiency. In cases of cardiac arrest, stroke, or anaphylactic shock, the system could suggest precise interventions based on evidence-based protocols, patient allergies, and historical medical conditions, reducing errors and improving survival rates. Furthermore, AI-enhanced ambulance navigation systems could predict traffic congestion, road hazards, and optimal hospital destinations, ensuring that critical patients reach specialized care units in the shortest time possible.

This AI-driven framework could also be applied to disaster response teams, military operations, law enforcement crisis situations, and hazardous material handling, offering predictive risk modeling, real-time biometric tracking, and strategic assistance based on continuously updated live data feeds, historical case studies, and situational simulations. By integrating AI into firefighting, aviation safety, EMS, and first responder operations, this invention dramatically improves efficiency, reduces human error, and enhances life-saving decision-making in extreme, high-pressure environments.

### Detailed Description of Figures

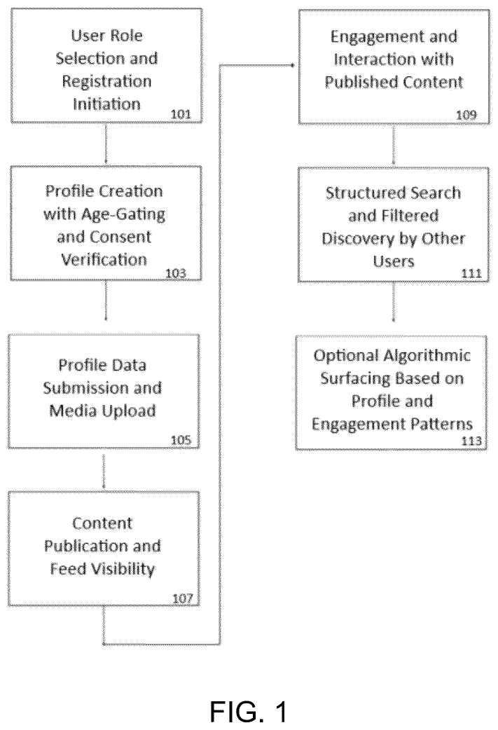

### FIG. 1.101—Data Collection and Integration

The system begins by collecting raw data from multiple sources, including video footage, biometric sensors, environmental sensors, historical databases, and real-time performance metrics. For sports applications, this may include game film, player statistics, motion-tracking sensors, and historical team performance data. In medical applications, the data sources may include patient vitals, electronic health records, and real-time surgical feeds, while firefighting or aviation implementations would rely on thermal imaging cameras, aircraft diagnostics, and weather patterns. The AI ingests, synchronizes, and structures this data for further processing, ensuring seamless integration between real-time and historical information.

### FIG. 1.103—Real-Time Video and Sensor Processing

Once the data is collected, the system processes live video feeds and sensor inputs using computer vision, deep learning algorithms, and real-time telemetry analysis. In sports applications, pose estimation models track player movements, while in medical environments, surgical cameras and patient monitors are analyzed for procedural accuracy and early signs of complications. For firefighters and EMS, thermal imaging and structural integrity assessments are conducted in real time to identify fire spread patterns, hazardous conditions, and safe evacuation routes. This step ensures high-speed, frame-by-frame analysis to capture every crucial event.

### FIG. 1.105—Pattern Recognition and Biomechanical Analysis

The AI then applies advanced pattern recognition techniques to detect recurring behaviors, tactical trends, and physical movements. In sports, this includes identifying player tendencies, in-game decision triggers, and biomechanical inefficiencies. For medical applications, anomalous heart rhythms, respiratory distress markers, or irregular surgical movements are flagged. In firefighting or aviation, the AI detects structural collapse risks, unstable flight patterns, or firefighter fatigue indicators, alerting users before these factors escalate into crises. By mapping statistical probabilities and biomechanical profiles, the system enhances predictive accuracy across all domains.

### FIG. 1.107—Predictive Modeling and Trend Analysis

Once patterns are recognized, the system generates predictive models to forecast future occurrences based on past behaviors and environmental conditions. In sports, the AI predicts opponent strategies, play-calling tendencies, and player fatigue thresholds. For medical use, surgical complication risks, patient deterioration probabilities, and recommended intervention strategies are calculated. In aviation, flight path optimizations and turbulence response strategies are provided, while in emergency response, the AI determines fire growth patterns, structural stability, and triage prioritization. These predictions allow preemptive decision-making and proactive intervention.

### FIG. 1.109—User Interaction and AI-Driven Recommendations

The AI assistant interfaces with users via natural language processing (NLP), voice commands, and predictive dashboards, offering real-time recommendations, alerts, and strategic adjustments. In sports, coaches and players can ask for instant play breakdowns, tactical advice, or biomechanical corrections. In surgery, the AI can warn of procedural deviations, suggest adjustments, and alert to potential complications. Firefighters receive escape route recommendations, suppression strategies, and real-time danger alerts, while pilots can query in-flight conditions, receive emergency landing guidance, and adjust based on predictive warnings. This step ensures seamless AI-human interaction.

### FIG. 1.111—Continuous Learning and Model Refinement

The system continuously refines its accuracy by incorporating new data from each completed session, utilizing reinforcement learning and adaptive algorithms. As more games, surgeries, flight conditions, or emergency responses are processed, the AI updates its decision-making logic, enhances predictive accuracy, and fine-tunes biomechanical assessments. This ensures constant evolution and improvement, allowing the system to adapt to new challenges, changing tactics, and emerging risks.

### FIG. 1.113—Deployment and Multi-Domain Adaptation

Finally, the AI system is deployed across multiple industries, allowing it to operate in sports, healthcare, emergency response, aviation, and law enforcement. The same core analytics engine can analyze player performance in a game, predict surgical risks in an operating room, optimize a firefighter's response strategy, or assist pilots in critical flight conditions. By integrating domain-specific datasets and customizing user interfaces, the AI becomes a universal decision-support system applicable to any high-stakes environment where real-time analysis and predictive insights are crucial.

What is claimed is:

1. A system for AI-driven sports analysis and strategy optimization, comprising:
a. a video processing module configured to receive and analyze game footage using machine learning and computer vision algorithms;
b. a data aggregation module that collects and processes historical and real-time game data to identify trends, tendencies, and player-specific behavioral patterns;
c. a predictive modeling engine that generates strategic recommendations based on observed patterns in player performance, opponent tendencies, and team formations;
d. a natural language processing (NLP) interface that allows users to interact with the system via text or voice commands to query specific aspects of gameplay, player tendencies, and strategic insights;
e. a biomechanical analysis module configured to track and analyze the body mechanics, movement angles, and reaction times of individual athletes;
f. an automated scouting engine that ranks, evaluates, and compares players based on predefined performance metrics and projected career trajectories; and
g. a fan engagement platform that enables users to access interactive historical comparisons, predictive game analytics, and AI-generated statistical overlays.

2. The system of claim 1, wherein the video processing module uses convolutional neural networks (CNNs) to extract frame-by-frame motion data, identify player positioning, and determine play formations.

3. The system of claim 1, wherein the data aggregation module integrates publicly available sports data, proprietary team databases, and real-time game statistics to refine predictive accuracy.

4. The system of claim 1, wherein the predictive modeling engine utilizes reinforcement learning to continuously improve strategic recommendations based on game outcomes and player performance variations.

5. The system of claim 1, wherein the natural language processing (NLP) interface allows users to request game insights, player comparisons, and coaching recommendations through a conversational AI assistant.

6. The system of claim 1, wherein the biomechanical analysis module detects and evaluates an athlete's physical movements, including but not limited to:
a. shooting mechanics in basketball, including release angle, wrist positioning, and defender proximity;
b. throwing motion in football, including arm slot, foot placement, and pressure response;
c. pitching mechanics in baseball, including grip variation, release timing, and follow-through stability;
d. sprinting and agility movements in soccer, including acceleration rates, foot positioning, and defensive tracking.

7. The system of claim 1, wherein the automated scouting engine applies machine learning algorithms to compare player statistics across multiple games, generating customized scouting reports for recruiters and coaches.

8. The system of claim 1, wherein the fan engagement platform provides an interactive AI-driven experience by:
a. offering real-time statistical overlays during live broadcasts to highlight key performance metrics;
b. allowing users to generate custom highlight reels based on specific queries, such as “show me all successful three-pointers made in the final minute of a game”;
c. enabling comparative player analysis, allowing fans to see how current players stack up against past athletes based on key statistical indicators.

9. The system of claim 1, further comprising an AI-driven tendency analysis engine that evaluates opponent behaviors and signals likely play-calling decisions based on prior game footage and situational context.

10. The system of claim 1, wherein the predictive modeling engine calculates the probability of specific in-game decisions, such as a team's likelihood of attempting a fourth-down conversion in football, executing a fast break in basketball, or shifting defensive formations in response to offensive adjustments.

11. The system of claim 1, wherein the AI-powered coaching assistant provides real-time recommendations to teams during games, suggesting optimal strategic decisions based on:
a. historical success rates of similar plays in comparable game situations;
b. opponent weaknesses identified through prior game analysis;
c. player fatigue indicators and substitution recommendations.

12. The system of claim 1, wherein the biomechanical analysis module is further configured to identify and alert players of unintentional behavioral tells, allowing them to adjust and reduce predictability in competitive environments.

13. The system of claim 1, wherein the automated scouting engine dynamically adjusts player rankings based on recent performance trends, real-time game statistics, and machine learning-driven player comparisons.

14. The system of claim 1, wherein the fan engagement platform integrates with augmented reality (AR) devices to provide an immersive sports analytics experience, allowing users to view AI-generated overlays and interactive data visualizations in real time.

15. A method for AI-powered sports analysis, comprising:
a. collecting video and statistical data from live and recorded games;
b. processing the data using machine learning algorithms to extract player tendencies, team strategies, and biomechanical patterns;
c. applying predictive modeling to anticipate future gameplay decisions and recommend optimal strategies;
d. generating AI-driven reports for athletes, coaches, and scouts based on comparative performance evaluations;
e. providing real-time fan engagement insights, including statistical overlays and historical player comparisons;
f. enabling natural language interaction for customized game analysis and tactical recommendations;
g. refining predictive models through reinforcement learning, continuously improving strategic output based on real-world game results.

16. The method of claim 15, wherein the AI system continuously updates its predictive accuracy by integrating new game data, learning from outcomes, and adjusting strategic recommendations accordingly.

17. The method of claim 15, further comprising an interactive AI assistant that provides contextual, play-by-play breakdowns, highlighting decision-making tendencies, biomechanical inefficiencies, and optimal strategic adjustments for teams, coaches, and individual athletes.
